(19) United States
(12) Patent Application Publication
(10) Pub. No.: US 2016/0298798 A1
(43) Pub. Date: Oct. 13, 2016

(54) Assembly for Connecting a Tube

(71) Applicant: Caterpillar Inc., Peoria, IL (US)

(72) Inventors: Bryan Rickards, Oswego, IL (US); Carl Rempert, Shorewood, IL (US); Patrick Considine, Aurora, IL (US); Sarfraz Alam, Peoria, IL (US); Christian Sabotta, Washington, IL (US)

(73) Assignee: Caterpillar Inc., Peoria, IL (US)

(21) Appl. No.: 14/680,556

(22) Filed: Apr. 7, 2015

(51) Int. Cl. F16L 23/00; F16L 27/08; F16L 21/08

(52) U.S. Cl. CPC F16L 23/006; F16L 21/08; F16L 27/08

(57) ABSTRACT

A tube assembly is provided for connecting a tube with an external system. The tube assembly includes a spherical flange that is attached to the end of the tube in various ways. The spherical flange can include a triangular shaped groove that receives the sealing member. The spherical flange is then inserted into a cup flange with the tube connected thereto. Connecting members are used to couple the captive flange and the cup flange together to help restrict the degrees of rotation or movement of the spherical flange to about 5° to 9° in relation to an axis.

### TECHNICAL FIELD

The present disclosure relates to a connection and more particularly to a connection between a spherical flange and a tube.

### BACKGROUND

Tube assemblies are used in various hydraulic, pneumatic and structural joints. Typically, in joints having fixed tube ends, a tube end is rigidly coupled to the joint. The joints require orientation to be aligned to the bends in a tube. A template and/or a jig may be used to assist in the orientation of the joints. However, a single template and/or jig may be used for only one type of tube assembly due to specific requirements of the particular tube assembly. Therefore, multiple templates and/or jigs have to be provided for various types of tube assemblies. Further, storage, transport and maintenance of the templates and/or jigs may also be required. Consequently, costs associated with the assembly may increase.

Additionally, tolerance stack-up can cause difficulties for tube assemblies to be connected to a machine. Thus, when the tube end components do not align properly, the technician will attempt to force the tube into place causing unsafe conditions and damage to the tube leading to failure of the component.

U.S. Pat. No. 7,712,793 teaches a ball and socket-type swivel connector for use with second stage scuba regulators used by scuba divers. The ball is made from a metal with good corrosion resistance. The ball is held in position by a low friction bushing. The bushing, compresses the metal swivel ball with light assembly pressure. This is accomplished by machining or molding the same radius of the swivel ball into one side of the low friction bushing. No seawater can enter the swivel. The ball has a unique O-ring slot or channel that completely encircles the ball along a path that permits an O-ring to wipe the bushing upon swiveling of the connector and prevents seawater from entering the swivel. No area exists for seawater to collect around the O-ring. The preferred aspect uses a high-grade stainless steel swivel ball, low friction polymer bushing material and an internally lubricated low friction O-ring. A wiper ring boot, a ball and socket wiper that utilizes an outer boot as a wiper ring, keep sand and contamination out of the rotational mechanism of the swivel. Abstract. However, the ball and socket do not allow for various connections that may be required and that there is no flare at the bottom of the ball to prevent flow restrictions.

There is a need for a rotating flange with a limited degree of freedom that can be adapted to receive various types of connections desired by the user.

### SUMMARY

In one aspect, the disclosure describes a tube assembly for connecting a tube to a system including a captive flange configured to receive a connecting member and having a first cavity, a spherical flange having an upper portion, a bottom portion and a spherical portion, the upper portion being received in the captive flange and connectable to the tube, a triangular shaped groove formed at the bottom portion of the spherical flange, a sealing member positioned in the triangular shaped groove, a cup flange configured to receive the bottom portion of the spherical flange in a second cavity and to receive the connecting member, and a leg formed at the bottom portion of the spherical flange and configured to mate with a surface of the cup flange, wherein the spherical flange's degrees of rotation relative to an axis is limited by an angled portion of the first cavity

In another aspect, the disclosure describes a spherical flange for a tube assembly including an upper portion configured to be connectable to a tube, a spherical portion configured to mate with a cavity of a cup flange, and a bottom portion configured with a triangular shaped groove and legs that are flared.

### BRIEF DESCRIPTION OF THE DRAWINGS

FIG. 1 illustrates an exploded view of a tube assembly according to an aspect of the disclosure.

FIG. 2 illustrates an assembled tube assembly having a spherical flange with extended legs according to an aspect of the disclosure.

FIG. 3A illustrates the triangular shaped groove according to an aspect of the disclosure.

FIG. 3B illustrates the triangular shaped groove according to another aspect of the disclosure.

FIG. 4 illustrates the tube assembly with a spherical flange according to another aspect of the disclosure.

FIG. 5 illustrates the tube assembly with a braze connection between the tube and the spherical flange according to an aspect of the disclosure.

FIG. 6 illustrates the tube assembly with a mechanical joint connection between the tube 108 and the spherical flange according to an aspect of the disclosure.

FIGS. 7 and 8 illustrate the tube assembly with the spherical flange having a threaded connection according to an aspect of the disclosure.

FIGS. 9 and 10 illustrate the tube assembly with the spherical flange having a threaded connection according to an aspect of the disclosure

### DETAILED DESCRIPTION

The present disclosure relates to a tube assembly for connecting a spherical flange with a tube. References will now be made in detail to specific aspects of the disclosure or features, examples of which are illustrated in the accompanying drawings. Wherever possible, the same reference numbers will be used throughout the drawings to refer to the same or like parts.

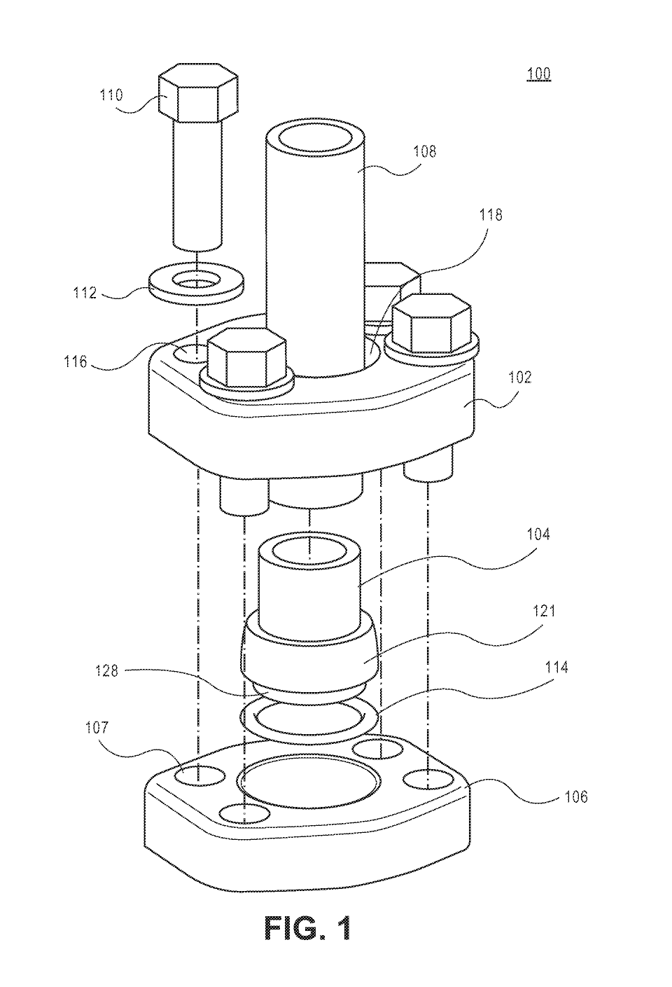

FIG. 1 illustrates an exploded view of a tube assembly 100 according to an aspect of the disclosure. The tube assembly 100 is configured to mate with an external system (not shown) and transport fluids in liquid or gaseous states. The external system may be a hydraulic or pneumatic system, such as a fluid valve, a port, a hydraulic cylinder, a pneumatic cylinder and the like. Additionally, the external system may be part of a machine, a vehicle or an apparatus that employs hydraulic and/or pneumatic components.

The tube assembly 100 may include a captive flange 102, a spherical flange 104, a cup flange 106, a tube 108, a connecting member 110, a washer 112, and a sealing member 114. The captive flange 102 is configured to include a first cavity 118 that can receive the tube 108 and first fastening holes 116 that can receive connecting members 110. The connecting members 110, such as a bolt, screw and the like, couple the captive flange 102 with the cup flange 106. Washers 112 are provided so that the connecting members 110 can better mate with the captive flange 102. The tube 108 can be made of any material, such as an alloy, and configured to transport various fluids under pressure. The tube 108 is connected to the spherical flange 104 in various manners, such as welding, threaded coupling and the like and will be further discussed below.

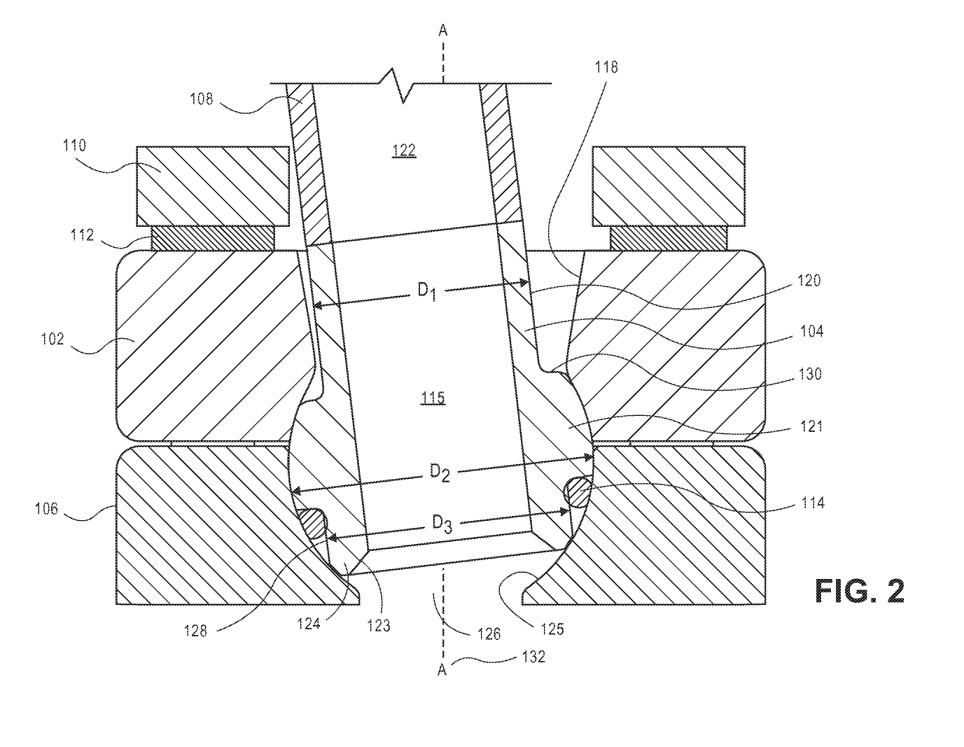

The spherical flange 104 can be made of a material including alloy, steel and the like. The spherical flange 104 also includes a triangular shaped groove 128 that is cut into a spherical portion 121 in order to receive the sealing member 114. The sealing member 114, such as an O-ring prevents fluids from entering the tube assembly 100 from the external system when the tube assembly 100 is coupled thereto. The spherical flange 104 is configured to have limited degrees of movement of approximately 5°-9° from a central axis A 132 (FIG. 2). The cup flange 106 includes second fastening holes 107 that receive connecting members 110.

FIG. 2 illustrates an assembled tube assembly 100 having a spherical flange 104 with extended legs 124 according to an aspect of the disclosure. The connecting members 110 are received in the first fastening holes 116 of the captive flange 102 and in the second fastening holes 107 of the cup flange 106. The connecting members 110 can also extend into the external system so that the tube assembly 100 can be bolted thereon. Thus, when the connecting members 110 are tightened, in a conventional manner, the captive flange 102 and the cup flange 106 are tightly coupled together. As shown in FIG. 2, the spherical flange 104 is received (friction fit) within a first cavity 118 of the captive flange 102 and a second cavity 125 of the cup flange 106.

Due to the fact that the captive flange 102 and the cup flange 106 are tightly coupled together, the spherical flange 104 is limited to about 5°-9° of rotation from axis A 132. In one aspect of the disclosure, the spherical flange 104 is limited to about 7° of rotation from axis A 132. The limited degree rotation by the spherical flange 104 prevents too much rotation that can damage the tube assembly 100 or the connection between the tube 108 and the spherical flange 104. The degrees rotation by the spherical flange 104 can be limited by having the first cavity 118 angled so that the angle is furthest away from the axis A 132 at a top portion of the captive flange 102 and is closest to the axis A at a bottom portion of the captive flange 102. Thus, an upper portion 120 of the spherical flange 104 can only move until it contacts the angled portion of the first cavity 118. Additionally, the degrees rotation by the spherical flange 104 can be limited by legs 124 positioned at a bottom portion of the spherical flange 104. The legs 124 having an angled portion 123 are configured to touch a surface of the second cavity 125, which is rounded or spherical in order to receive the spherical portion 121 and the angled portion 123. As the legs 124 travel the surface of the second cavity 125, rotation of the spherical flange 104 can be limited due to the positioning of the legs 124 and the position of the spherical flange's upper portion 120 contacting with the angled portion of the first cavity 118. The legs 124 are angled or flared to prevent or reduce flow restrictions the may occur.

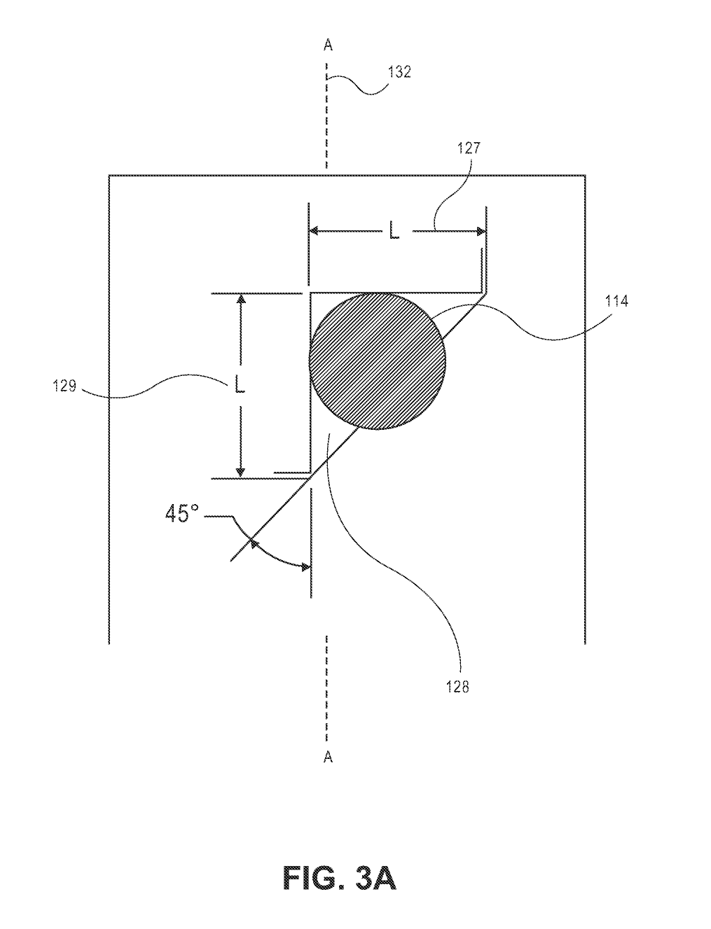

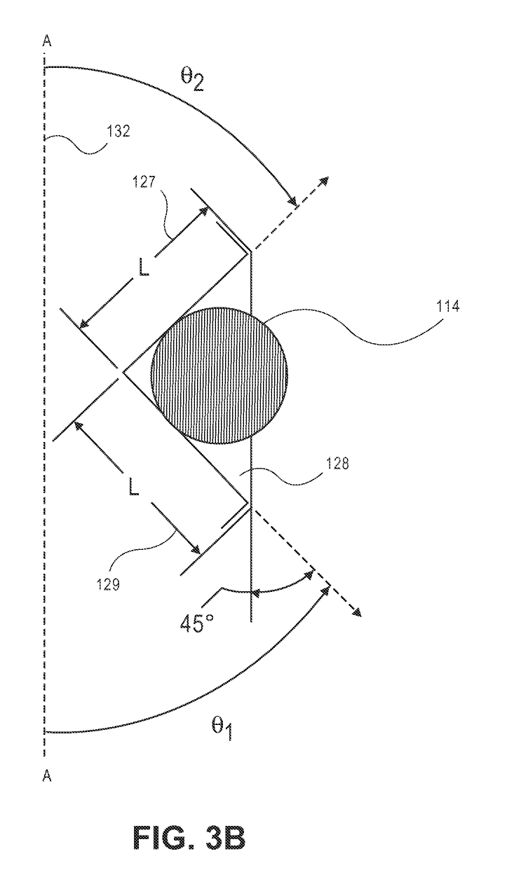

Also shown in FIGS. 2 and 3 is the triangular shaped groove 128 that is cut below the spherical portion 121 and defines the outer surface of the leg 124. A sealing member 114 is provided to prevent fluids from traveling from the external system through opening 126 and into the tube assembly 100. Also shown in FIG. 2 is shoulder 130 formed on a top portion of the spherical portion 121.

In one aspect of the disclosure, various portions of the spherical flange 104 have various outer diameters. The upper portion 120 has an outer diameter D1, while the spherical portion 121 has an outer diameter D2 and the leg 24 has an outer diameter D3. In one aspect of the disclosure, D2 is larger than D3, which is a larger than D1. However, in other aspects, the diameters may be the same or that D1 is larger than D3 and the like.

Also shown in FIG. 2, the tube 108 includes a tube passage 122, which allows fluids to flow there through to spherical flange passage 115. Thus, fluids may flow from tube passage 122 to spherical flange passage 115 and then to opening 126 the leads into the external system.

FIG. 3A illustrates the triangular shaped groove 128 according to an aspect of the disclosure. The triangular shaped groove 128 may be machine cut into the spherical flange 104 and also may define the outer diameter of the leg 124. The triangular shaped groove 128 can have a first length 127 and a second length 129 that are the same or different lengths. In one aspect of the disclosure, the first length 127 is smaller than the second length 129 or vice versa. In essence, the first and second lengths form a right angle. Additionally, in this aspect of the disclosure, the first length 127 can be perpendicular to axis A 132 and the second length 129 can be parallel or on the same axis as axis A 132.

FIG. 3B illustrates the triangular shaped groove 128 according to another aspect of the disclosure. In this aspect of the disclosure, the triangular shaped groove 128 can be at a different angle in relation to axis A 132. That is, the first length 127 is not perpendicular to axis A 132 and the second length 129 is not parallel or not on the same axis as axis A 132. In one aspect, Θ₁ and/or Θ₂ can be from 1° to 89°, 30° to 60°, 40° to 50° and other degrees in relation to axis A 132. For example, Θ₁ can be 45° and Θ45° from the axis A 132. Other combinations of Θ₁ and Θ₂ are possible.

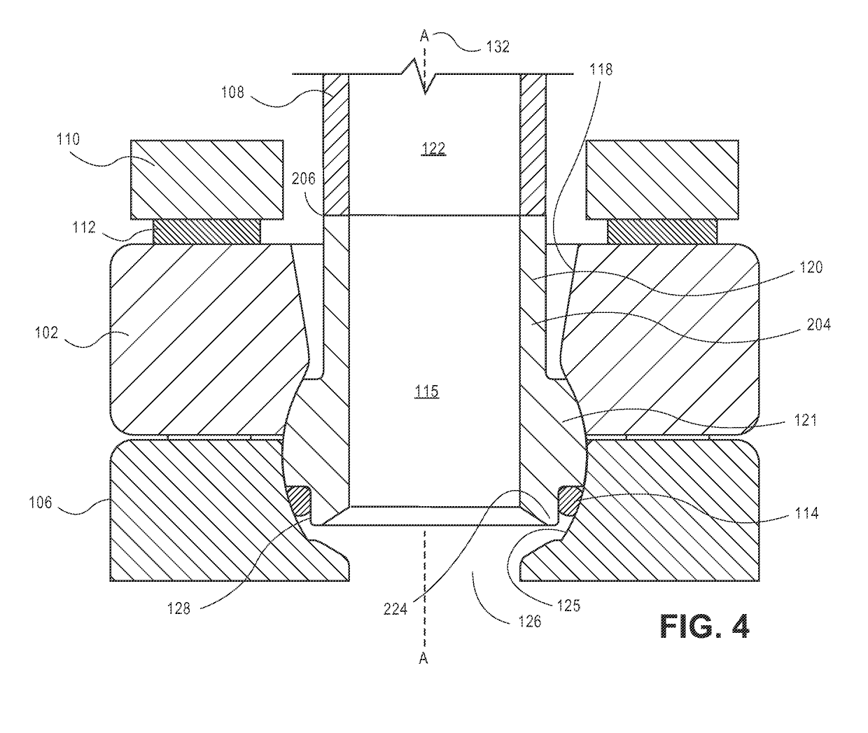

FIG. 4 illustrates the tube assembly 100 with a spherical flange 204 according to another aspect of the disclosure. The spherical flange 204 is similar to the spherical flange 104 shown in FIG. 2 but has legs 224 that are configured not to touch the surface of the second cavity 125. Thus, during use only the spherical portion 121 touches the surface of the second cavity 125. Also shown in FIG. 4 is a connection 206 formed where tube 108 connects with the upper portion 120 of the spherical flange 204. In one aspect of the disclosure, the connection 206 is a weld connection such as gas tungsten arc welding (GTAW) or tungsten inert gas (TIG) welding and the like. In this aspect of the disclosure, the degrees rotation by the spherical flange 204 can be limited by having the first cavity 118 angled so that the angle is furthest away from the axis A 132 at a top portion of the captive flange 102 and is closest to the axis A at a bottom portion of the captive flange 102. Thus, an upper portion 120 of the spherical flange 204 can only move until it contacts the angled portion of the first cavity 118.

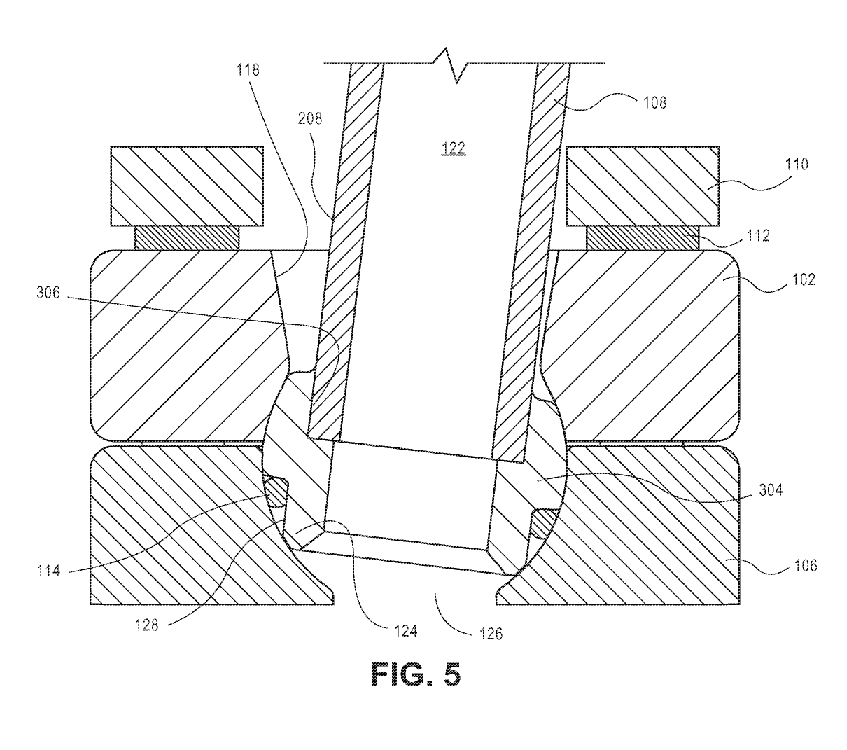

FIG. 5 illustrates the tube assembly 100 with a braze connection between the tube 108 and the spherical flange 304 according to an aspect of the disclosure. In this aspect, the spherical flange 304 does not include the upper portion 120 and thus, is truncated. The spherical flange 304 includes a tube receiving portion 306 that receives the outer surface 208 of the tube 108 therein. This type of joint connection is known as a braze connection or silver brazing The process uses a silver-containing alloy with a melting temperature above 800° F. but below the melting point of the metals that are being joined. In brazing, the metals to be connected are heated, usually to a point slightly above the flow point of the silver filler metal, causing it to melt. The silver filler metal then flows between the two base materials by capillary attraction and bonds to their surfaces through atomic attraction and diffusion. That is, the silver filler material flows between the outer surface 208 of the tube 108 and the tube receiving portion 306 thereby joining the tube 108 with the spherical flange 304.

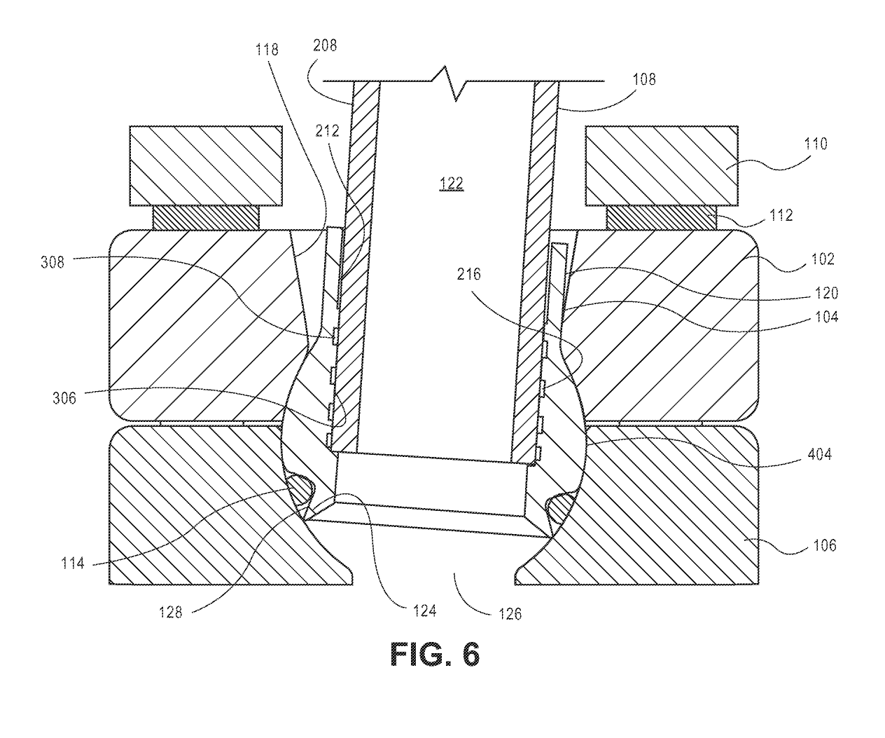

FIG. 6 illustrates the tube assembly 100 with a mechanical joint connection between the tube 108 and the spherical flange 404 according to an aspect of the disclosure. In this aspect of the disclosure, the mechanical joint connection may be a form of a threaded connection. The outer surface 208 of the tube 108 includes a first set of threads 216 while the inner surface of the tube receiving portion 306 includes a second set of threads 308 that are complementary to the first set of threads. Thus, in order to make the mechanical joint connection, the user can rotate either the tube 108 and/or the spherical flange 404, respectively, until a good connection is made.

In another aspect of the disclosure for the mechanical joint, the tube receiving portion 306 has 3 to 4 grooves or straight cuts into its inner diameter. After the tube 108 (straight end without any machining) is inserted into the tube receiving portion 306, a tool is inserted into the tube. Inside the tool are rollers located around a tapered mandrel. The tool forces the mandrel forward which in turn causes the rollers to expand out. This causes the tube material to be pressed into the grooves, thus locking the two parts (tube and spherical flange) together.

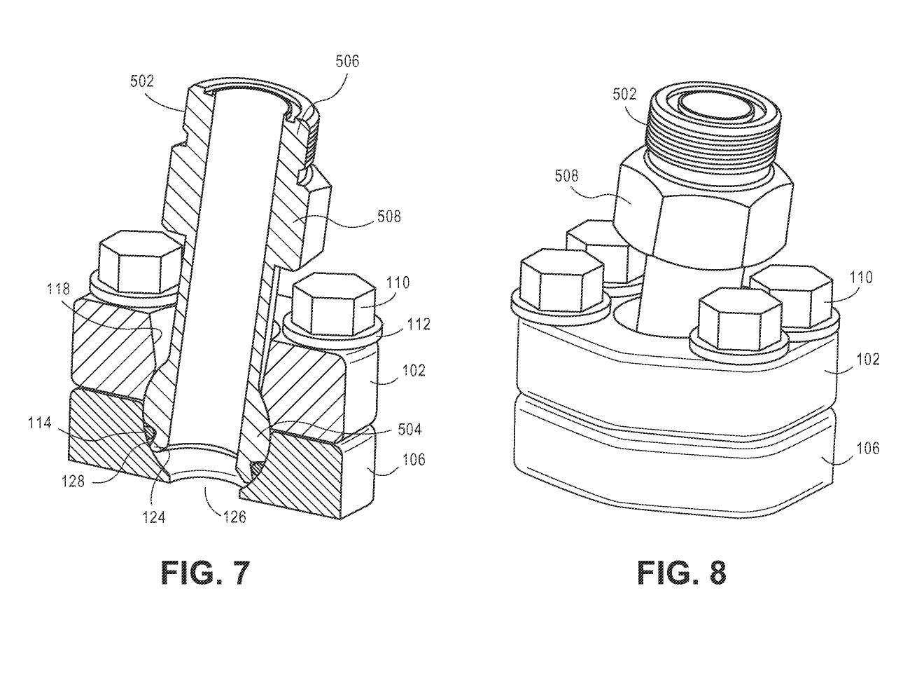

FIGS. 7 and 8 illustrate the tube assembly 100 with the spherical flange 504 having a threaded connection 502 according to an aspect of the disclosure. In this aspect of the disclosure, the spherical flange 504 includes the threaded connection 502, such as O-ring face seal (ORFS) fitting at an end that connects with the tube 108 (not shown). The threaded connection 502 can be compliant with SAE J1453 and ISO 8434-3. In essence, this type of connection is designed for leak-free use to around 6000 PSI. The O-ring in the face of the straight thread male end 506 seals against the flat face female seat (not shown) and is mechanically held in place by a swivel nut 508.

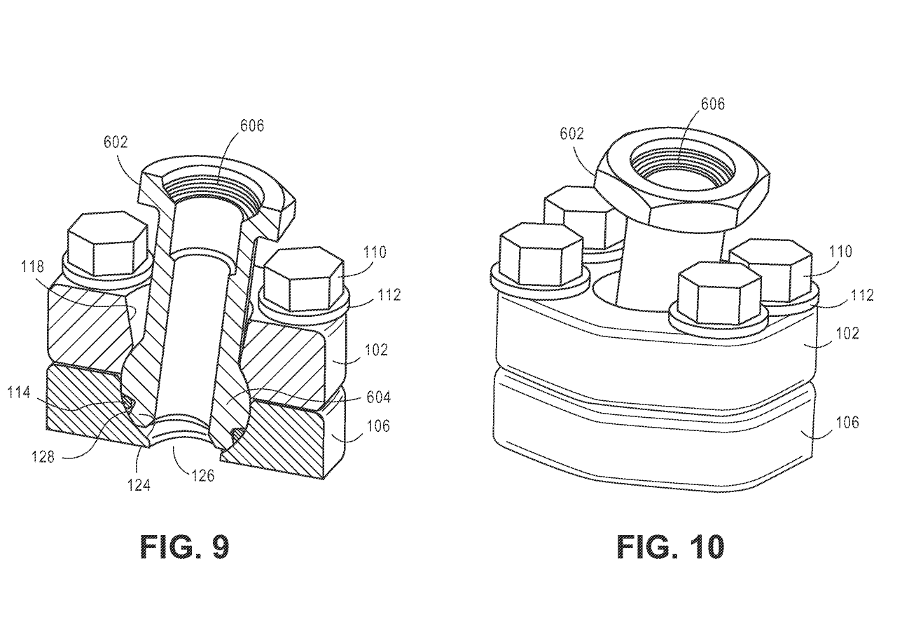

FIGS. 9 and 10 illustrate the tube assembly 100 with the spherical flange 604 having a threaded connection 602 according to an aspect of the disclosure. In this aspect of the disclosure, the spherical flange 604 includes the threaded connection 602, such as straight thread O-ring boss (STOR) fitting at an end that connects with the tube 108 (not shown). The threaded connection 602 can be compliant with SAE 514. In essence, this straight thread connection uses the same threads as the JIC 37°. However the 37° flare has been removed and an O-ring has been added. When mated with a female O-ring boss port, the O-ring is trapped in a special tapered counter bore 606 to affect the seal.

In another aspect of the disclosure, although the figures illustrate the cup flange 106 being part of the tube assembly 100, the cup flange 106 can be part of the external system onto which captive flange 102 is bolted thereto. That is the external system already includes the cup flange 106 on the top of the external system. In still another aspect of the disclosure, the cup flange 106 can be machined into the external system and then the captive flange can be bolted thereto.

In order to assemble the tube assembly 100, the spherical flange 104 is attached to the end of the tube 108 in any of the various ways discussed herein. The spherical flange 104 can include the triangular shaped groove 128 that receives the sealing member 114. The spherical flange 104 is then inserted into the cup flange 106 with the tube 108 connected thereto. The spherical flange 104 is flared at the bottom to prevent flow restriction. A captive flange 102 is used to press the spherical flange 104 into the cup flange 106. Connecting members 110 along with the washers 112 are used to tighten the captive flange 102 and the cup flange 106 together and once connected together, the captive flange and the cup flange help to restrict the degree of rotation or movement of the spherical flange to about 5° to 9° in relation to an axis 132.

### INDUSTRIAL APPLICABILITY

The present disclosure is applicable to a tube assembly 100 for connecting a tube 108 to an external system. The tube assembly 100 is configured to mate with the external system and transport fluids in liquid or gaseous states. The external system may be a hydraulic or pneumatic system, such as a fluid valve, a port, a hydraulic cylinder, a pneumatic cylinder and the like. Additionally, the external system may be part of a machine, a vehicle or an apparatus that employ hydraulic and/or pneumatic components.

Tolerance stack up can make it difficult to connect the tube 108 to the machine, such as hydraulic or pneumatic systems in machine or vehicle. Tolerance stack-ups are vital to address mechanical fit and mechanical performance requirements when joining components together. Thus, when tubes 108 do not connect properly to the corresponding mounting points, assemblers may attempt to force the tube 108 into place leading to unsafe conditions for the assemblers, as well as, cause damage to the tube and ultimately contributing to the tube failure. Tube failures can damage the machine and require significant downtime to repair the machine, thereby, require additional time in which to complete a project and money for the repairs.

The tube assembly 100 may include a captive flange 102, a spherical flange 104, a cup flange 106, a tube 108, a connecting member 110, a washer 112, and a sealing member 114. The captive flange 102 is configured to include the first cavity 118 that can receive tube 108 and first fastening holes 116 that can receive connecting members 110. The connecting members 110, such as a bolt, screw and the like, couple the captive flange 102 with the cup flange 106. Washers 112 are provided so that the connecting members 110 can better mate with the captive flange 102. The spherical flange 104 also includes a triangular shaped groove 128 that is cut into a spherical portion 121 in order to receive the sealing member 114. The sealing member 114, such as an O-ring prevents fluids from entering the tube assembly 100 from the external system. Due to the fact that the captive flange 102 and the cup flange 106 are tightly coupled together, the spherical flange 104 is limited to about 5°-9° of rotation from axis A 132. In one aspect of the disclosure, the spherical flange 104 is limited to about 7° of rotation from axis A 132. The limited degree rotation by the spherical flange 104 prevents too much rotation that can damage the tube assembly 100 or the connection between the tube 108 and the spherical flange 104.

We claim:

1. A tube assembly for connecting a tube to a system comprising:
a captive flange configured to receive a connecting member and having a first cavity;
a spherical flange having an upper portion, a bottom portion and a spherical portion, the upper portion being received in the captive flange and connectable to the tube;
a triangular shaped groove formed at the bottom portion of the spherical flange;
a sealing member positioned in the triangular shaped groove;
a cup flange configured to receive the bottom portion of the spherical flange in a second cavity and to receive the connecting member; and
a leg formed at the bottom portion of the spherical flange and configured to mate with a surface of the cup flange, wherein the spherical flange's degrees of rotation relative to an axis is limited by an angled portion of the first cavity.

2. The assembly of claim 1, wherein the leg has an angled portion configured to reduce flow restrictions.

3. The assembly of claim 1, wherein the connecting member couples the captive flange and the cup flange together.

4. The assembly of claim 3, wherein when the captive flange and the cup flange are coupled together, degrees of rotation by the spherical flange are further limited.

5. The assembly of claim 1, wherein the second cavity is spherical in shape.

6. The assembly of claim 1, wherein the upper portion of the spherical flange connects to the tube via one of a braze connection, a mechanical connection or a weld connection.

7. The assembly of claim 1, wherein the degrees of rotation is between 5°-9°.

8. The assembly of claim 7, wherein the degree of rotation is 7°.

9. The assembly of claim 1, wherein the upper portion has a first diameter, the bottom portion has a second diameter and the spherical portion has a third diameter and wherein the first, second and third diameters are different in size from each other.

10. The assembly of claim 9, wherein the second diameter is larger than the third diameter, which is larger than the first diameter.

11. The assembly of claim 1, wherein the triangular shaped groove includes a first length that is perpendicular to the axis and a second length that is parallel to the axis.

12. The assembly of claim 1, wherein the triangular shaped groove includes a first length that is not perpendicular to the axis and a second length that is not parallel to the axis.

13. A spherical flange for a tube assembly comprising:
an upper portion configured to be connectable to a tube;
a spherical portion configured to mate with a cavity of a cup flange; and
a bottom portion configured with a triangular shaped groove and legs that are flared.

14. The spherical flange of claim 13 further comprising a sealing member positioned in the spherical portion.

15. The spherical flange of claim 13, wherein the legs have a length that is capable of mating with a surface of the cavity of the cup flange.

16. The spherical flange of claim 13, wherein the triangular shaped groove has a first length and a second length that are different.

17. The spherical flange of claim 15, wherein when the legs are mated with the surface of the cup flange, the legs limit degrees of rotation by the spherical flange.

18. The spherical flange of claim 17, wherein the degrees of rotation is between 5°-9°.

19. The spherical flange of claim 18, wherein the degree of rotation is 7°.

20. The spherical flange of claim 13, wherein the upper portion has a first diameter, the bottom portion has a second diameter and the spherical portion has a third diameter and wherein the first, second and third diameters are different in size from each other.

21. The spherical flange of claim 20, wherein the second diameter is larger than the third diameter, which is larger than the first diameter.

22. The spherical flange of claim 13, wherein the upper portion is connectable to the tube via one of a braze connection, a mechanical connection or a weld connection.

23. The spherical flange of claim 13, wherein the triangular shaped groove includes a first length that is perpendicular to the axis and a second length that is parallel to the axis.

24. The spherical flange of claim 13, wherein the triangular shaped groove includes a first length that is not perpendicular to the axis and a second length that is not parallel to the axis.
